(19) United States
(12) Patent Application Publication
(10) Pub. No.: US 2026/0004170 A1
(43) Pub. Date: Jan. 1, 2026

(54) ACTIVE QUANTUM MEMORY SYSTEMS AND TECHNIQUES FOR MITIGATING DECOHERENCE IN A QUANTUM COMPUTING DEVICE

(71) Applicant: SavantX, Inc., Jackson, WY (US)

(72) Inventors: Michael L. Rogers, Los Alamos, NM (US); Robert L. Singleton, JR., Santa Fe, NM (US); David L. Ostby, Lamy, NM (US); Edmond A. Heinbockel, Alpine, WY (US)

(21) Appl. No.: 18/189,612

(22) Filed: Mar. 24, 2023

Related U.S. Application Data
(63) Continuation-in-part of application No. 17/584,219, filed on Jan. 25, 2022, now abandoned.

(51) Int. Cl. G06N 10/20; G06N 10/40

(52) U.S. Cl. CPC G06N 10/20; G06N 10/40

(57) ABSTRACT

Systems and techniques for active quantum memory (AQM) and quantum circuits with feedback are described. For instance, one or more aspects of the present disclosure may enable the indefinite storage of one or more qubits via a sequence of quantum teleportations or quantum swaps involving the rapid periodic executions of a standard teleportation or swap protocols with feedback (e.g., provided the total feedback cycle time is less than the decoherence time for a qubit). The stored quantum state may be passed repeatedly back-and-forth between two of the qubits, and the stored quantum state may be maintained by the input energy on each cycle required to initialize the entangled qubit pair (e.g., where the cycle period is chosen to be less than the decoherence time of the qubits to maintain state information over many cycles).

This application is a continuation-in-part of U.S. application Ser. No. 17/584,219, filed Jan. 25, 2022, for ACTIVE QUANTUM MEMORY SYSTEMS AND TECHNIQUES FOR MITIGATING DECOHERENCE IN A QUANTUM COMPUTING DEVICE, which is incorporated in its entirety herein by reference.

### BACKGROUND OF THE INVENTION

### 1. Field of the Invention

The present invention relates generally to quantum memory, and more specifically to active quantum memory systems and techniques for mitigating decoherence in a quantum computing device.

### 2. Discussion of the Related Art

Various systems and processes are known in the art for active quantum memory systems and techniques for mitigating decoherence in a quantum computing device.

Quantum computing is a subfield of information science that harnesses the collective properties of quantum states for computation tasks. For instance, quantum computing may utilize quantum state properties such as superposition, interference, entanglement, etc. to perform calculations and solve computational problems. In some cases, devices that perform such calculations and quantum computations may be known as quantum computers. Quantum computing devices may be capable of producing outputs and solving certain computational problems more efficiently than classical computers. For example, some quantum computing algorithms may speed up machine learning tasks, may solve problems such as integer factorization more efficiently, etc.

There are several types of quantum computing devices (also known as quantum computers, quantum computing systems, etc.), including the adiabatic quantum computer, quantum circuit model, quantum Turing machine, one-way quantum computer, various quantum cellular automata, etc. Some widely used models, such as the quantum circuit, are based on the quantum bit, or “qubit,” which is somewhat analogous to a bit in classical computation. A qubit can be in a 1 or 0 quantum state, or in a superposition of the 1 and 0 states. When a qubit is measured, however, the qubit is always a 0 or 1 quantum state (e.g., where the probability of either outcome depends on the qubit's quantum state immediately prior to measurement).

A challenge involved with constructing quantum computers and performing quantum computational operations is controlling or removing quantum decoherence. This usually means isolating the system from its environment (e.g., as the system may decohere as a result of the physical system's interactions with the external world). However, other sources of decoherence may also exist. Examples include quantum gates, lattice vibrations and background spins of the physical system used to implement the qubits, etc. Often, decoherence is irreversible (e.g., as it is non-unitary, effectively). As such, decoherence should often be avoided, or at least highly controlled. Accordingly, there is a need in the art for efficient techniques for mitigating decoherence in quantum computing systems.

### SUMMARY

A method, apparatus, non-transitory computer readable medium, and system for mitigating decoherence in a quantum computing device are described. One or more aspects of the method, apparatus, non-transitory computer readable medium, and system include teleporting a first value of a first qubit to a third qubit by the help of a second qubit, wherein the teleporting is started by forcing the second qubit to zero and forcing the third qubit to zero; performing a first Hadamard gate on the second qubit; performing a second Hadamard gate on the first qubit; performing a NOT gate on the third qubit, controlled by the second qubit; measuring the second qubit, thereby destroying the second qubit, and using the second qubit to perform a controlled NOT on the third qubit; measuring the first qubit, thereby destroying the first qubit, and controlling a Z gate on the third qubit as a function of the measuring of the first qubit, thereby effectuating teleportation of first value from the first qubit to the third qubit; and forcing the first qubit to zero, and forcing the second qubit to zero.

An active quantum memory system, a method for manufacturing active quantum memory systems, and techniques for using active quantum memory systems are described. One or more aspects of the apparatus, system, and methods include a first Hadamard gate coupled to a first qubit and receiving a value for the first qubit; a second Hadamard gate coupled to a second qubit; a first NOT gate coupled to a third qubit, and coupled at a first NOT gate control input to the second Hadamard gate at a second Hadamard gate output; a second NOT gate coupled to the second Hadamard gate output, and coupled at a second NOT gate control input to the first qubit and receiving the first value from the first qubit; a first qubit measurement coupled to the first Hadamard gate at a first Hadamard gate output, wherein the first qubit measurement is destructive of the first qubit; a second qubit measurement coupled to the second NOT gate output, wherein the second qubit measurement is destructive of the second qubit; a third NOT gate coupled to a first NOT gate output of the first NOT gate, and coupled at a third NOT gate control input to the second qubit measurement; and a Z gate coupled to the first qubit measurement at a control input of the Z gate, and coupled at a third NOT gate output to the third NOT gate, and providing a third qubit output.

### BRIEF DESCRIPTION OF THE DRAWINGS

FIG. 1 shows an example of a quantum computing system according to aspects of the present disclosure.

FIGS. 2 through 3 show examples of an active quantum memory (AQM) system according to aspects of the present disclosure.

FIGS. 4 through 6 show examples of an AQM block diagram according to aspects of the present disclosure.

FIG. 7 shows an example of an AQM system according to aspects of the present disclosure.

FIG. 8 shows an example of a process for quantum memory according to aspects of the present disclosure.

FIG. 9 shows an example of an AQM computing system according to aspects of the present disclosure.

FIG. 10 shows an example of an AQM system according to aspects of the present disclosure.

FIGS. 11 and 12 show examples of an AQM block diagram according to aspects of the present disclosure.

FIG. 13 shows an example of a process for quantum memory according to aspects of the present disclosure.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

As described above, a challenge involved with constructing quantum computers and performing quantum computational operations is controlling or removing quantum decoherence (e.g., which may arise based at least in part on quantum gates, lattice vibrations and background spins of the physical system used to implement the qubits, etc.).

For example, current quantum computing devices may be severely limited in their computing power by both the number of qubits which are currently available, and by the number of gates in a computational circuit. For example, the number of qubits (N_{q}) may generally be limited by the complexity of fabricating the physical qubits and control hardware, and the number of gates (N_{g}) may generally be limited by the coherence time of the qubits (e.g., since the gates are applied dynamically to qubits such that each qubit can “pass through” only a limited number of gates before decohering). To some extent different quantum computing algorithms may tradeoff between N_{q} and N_{g}. However, existing quantum computing hardware may be limited in complexity by what may be referred to as “quantum volume” (e.g., which may be approximated by, or represented as, N_{q}×N_{g}).

In order to efficiently enable quantum computing and communication technologies, advances in Quantum memory (QM) may be desired, if not required (e.g., as current QM technology may be ineffective for physical implementation, may not be ready for commercial application, etc.). Recently, some experimental quantum memories have been proposed or implemented using quantum optics, solid-state devices, superconducting qubits, nuclear magnetic resonance (NMR) devices, ion traps, and supercooled atoms. In such cases, the development focus has been on finding physical qubits with relatively long coherence times over which to store qubit states. As such, the qubit state may be passively stored in a long-lived storage qubit for a time period limited by its coherence time.

As described above, available qubits of a quantum computing system may be limited by the complexity of fabricating the physical qubits and control hardware, and available gates of a quantum computing system may be limited by the coherence time of the qubits (e.g., as qubit states may only be stored for time periods limited by coherence time).

Active quantum memory (AQM) systems and techniques described herein provide an active approach to QM, using a quantum teleportation circuit with feedback (e.g., which may effectively mitigate decoherence in quantum computing systems). For instance, one or more aspects of the systems and techniques described herein may enable the indefinite storage of one or more qubits via a sequence of quantum teleportations involving the rapid periodic executions of a standard teleportation protocol with feedback (e.g., provided the total feedback cycle time is less than the decoherence time for a qubit). As described in more detail herein, for each qubit stored, a pair of entangled qubits are injected on each cycle and two qubits are measured. AQM is an active process that maintains the coherence of the qubit state over long times by driving it at fixed frequency with the energy needed to prepare the entangled qubits. The stored quantum state may be passed repeatedly back-and-forth between two of the qubits comprising the device, maintained by the input energy on each cycle required to initialize the entangled qubit pair. Since the cycle period is chosen to be less than the decoherence time of the qubits, the state information may be maintained in one of two or more qubits over many cycles. In some examples, the fidelity of the stored state can be maintained by adding an error correction circuit within the basic AQM circuitry.

Accordingly, one or more aspects of the systems and techniques described herein may provide for more effective and long term quantum memory (e.g., which may improve efficiency of quantum computing applications, for instance, such as circuit-based (gate-based) quantum computing). The use of the described long-lived quantum memory may allow temporary storage for sections of quantum data (e.g., quantum data comprising registers of qubits). Long-lived quantum memory of AQM systems described herein may enable longer, deeper, and more complex calculations that may be performed by quantum circuit hardware, which may generally improve the performance of quantum computing systems, enable new applications of quantum computing systems, etc. For example, the improved (e.g., longer) storage times provided by the systems and techniques described herein may permit much more complex calculations to be efficiently performed on certain problems by quantum computing systems (e.g., which may be more feasible or more efficient than solving such problems via classical computers).

Another application of the described techniques may include portable storage of arbitrary quantum information (e.g., which may enable, for example, more efficient cryptography and security applications). Practical implementation of AQM in an optical embodiment, or another embodiment that doesn't require large cooling or vacuum equipment, may provide for relatively small portable quantum memory devices that may be developed. In some aspects, such small portable quantum memory devices may store quantum information in a physically portable form, which may enable various new and improved quantum computing applications (e.g., such as cryptography related applications, including quantum key distribution, etc.).

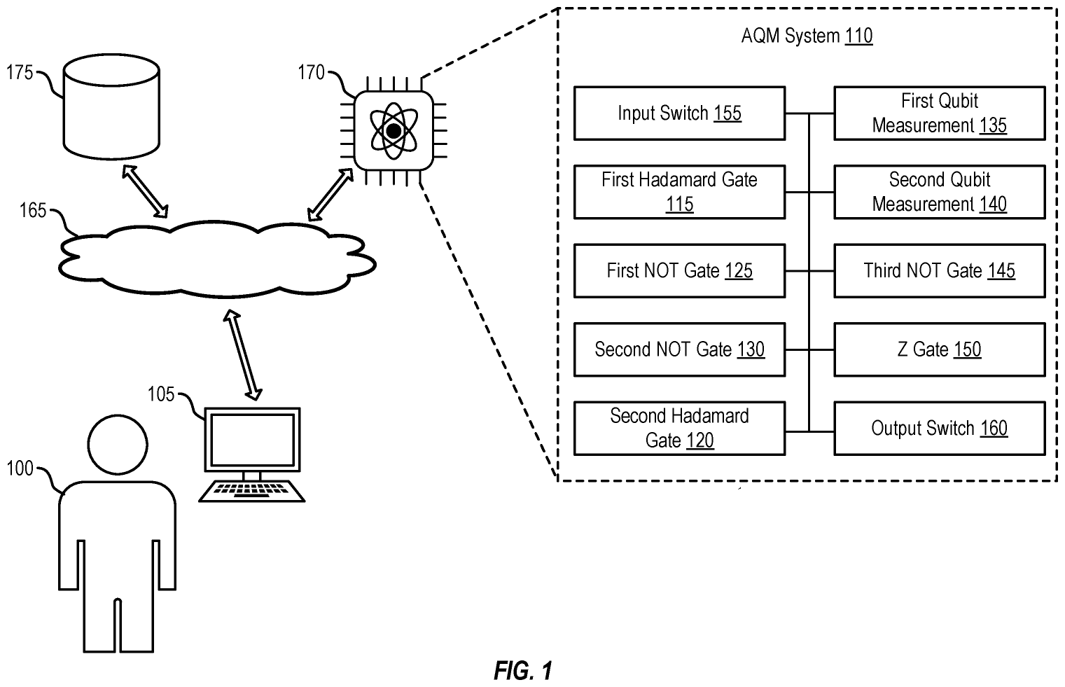

FIG. 1 shows an example of a quantum computing system according to aspects of the present disclosure. The example shown includes user 100, user device 105, cloud 165, computing device 170, and database 175.

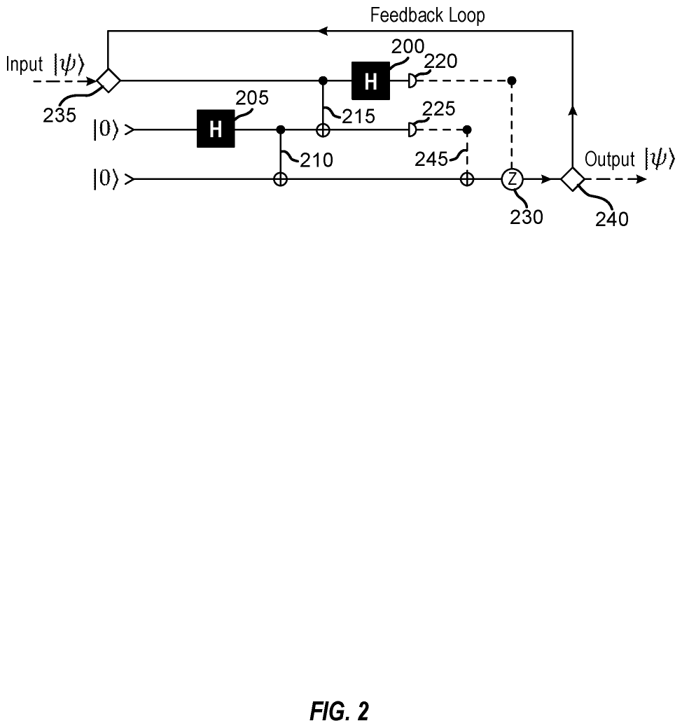

AQM system 110 provides an active approach to QM (e.g., using a quantum teleportation circuit with feedback as described in more detail herein, for example, with reference to FIGS. 2-7 and 9). In the example of FIG. 1, AQM system 110 effectively mitigates decoherence in quantum computing systems implemented at least in part via computing device 170. For example, user 100 may utilize a user device 105, which may access a computing device 170 (e.g., via cloud 165) for performing specialized computing tasks such as circuit-based (gate-based) quantum computing tasks, quantum cryptography and security applications, quantum computing algorithm calculations, etc.

A user device 105 may include any device utilizable or accessible to user 100, including, but not limited to, a personal computer, laptop computer, mainframe computer, palmtop computer, personal assistant, mobile device, or any other suitable processing apparatus.

A cloud 165 is a computer network configured to provide on-demand availability of computer system resources, such as data storage and computing power (e.g., such as computing power of computing device 170). In some examples, the cloud 165 provides resources without active management by the user 100. The term cloud is sometimes used to describe data centers available to many users 100 over the Internet. Some large cloud networks have functions distributed over multiple locations from central servers. A server is designated an edge server if it has a direct or close connection to a user 100. In some cases, a cloud 165 is limited to a single organization. In other examples, the cloud 165 is available to many organizations. In one example, a cloud 165 includes a multi-layer communications network comprising multiple edge routers and core routers. In another example, a cloud 165 is based on a local collection of switches in a single physical location.

Computing device 170 (e.g., a quantum computer, a quantum computing server, etc.) may generally utilize, or represent, one or more collective properties of quantum states for computation tasks. For instance, computing device 170 may utilize quantum state properties such as superposition, interference, entanglement, etc. to perform calculations and solve computational problems. Computing device 170 may be capable of producing outputs and solving certain computational problems more efficiently than classical computers (e.g., such as user device 105). For example, computing device 170 may implement quantum computing algorithms that may speed up machine learning tasks, problems such as integer factorization, etc.

In some examples, computing device 170 may include an adiabatic quantum computer, a quantum annealer computer, a quantum circuit model, a quantum Turing machine, a one-way quantum computer, various quantum cellular automata, etc. In some aspects, computing device 170 may implement one or more quantum circuits that are based on the quantum bit, or “qubit” (e.g., which in some aspects is somewhat analogous to a bit in classical computation). A qubit can be in a 1 or 0 quantum state, or in a superposition of the 1 and 0 states. When a qubit is measured, however, the qubit is always a 0 or 1 quantum state (e.g., where the probability of either outcome depends on the qubit's quantum state immediately prior to measurement).

In some aspects, computing device 170 provides one or more functions to users 100 linked by way of one or more of the various networks. In some cases, the computing device 170 includes a single microprocessor board, which includes a microprocessor responsible for controlling all aspects of the computing device 170. In some cases, a computing device 170 uses microprocessor and protocols to exchange data with other devices 105 and/or users 100 on one or more of the networks via hypertext transfer protocol (HTTP), and simple mail transfer protocol (SMTP), although other protocols such as file transfer protocol (FTP), and simple network management protocol (SNMP) may also be used. In some cases, a computing device 170 is configured to send and receive hypertext markup language (HTML) formatted files (e.g., for displaying web pages). In various embodiments, a computing device 170 comprises a server, a general purpose computing device, a mainframe computer, a quantum algorithm purpose computing device, a supercomputer, or any other suitable processing apparatus.

A database 175 is an organized collection of data. For example, a database 175 stores data in a specified format known as a schema. A database 175 may be structured as a single database, a distributed database, multiple distributed databases, or an emergency backup database. In some cases, a database controller may manage data storage and processing in a database 175. In some cases, a user 100 interacts with database controller. In other cases, database controller may operate automatically without user 100 interaction.

Generally, AQM system 110 may be included in, or implemented by, user device 105, computing device 170, or both. In the example of FIG. 1, computing device 170 includes AQM system 110. For instance, in the example of FIG. 1, computing device 170 may include AQM system 110, and the computing device 170 may be a server accessed by user device 105, via cloud 165, for performing specialized computer tasks (e.g., such as quantum computing operations, quantum computing algorithm computations, etc.).

In one aspect, AQM system 110 includes first Hadamard gate 115, second Hadamard gate 120, first NOT gate 125, second NOT gate 130, first qubit measurement 135, second qubit measurement 140, third NOT gate 145, Z gate 150, input switch 155, and output switch 160.

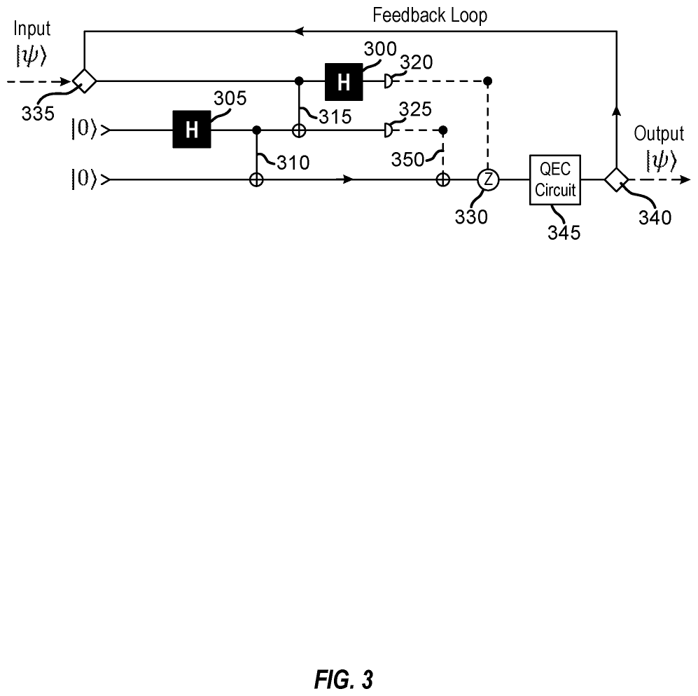

According to some aspects, first Hadamard gate 115 is coupled to a first qubit and receives a value for the first qubit. First Hadamard gate 115 is an example of, or includes aspects of, the corresponding element described with reference to FIGS. 2 and 3.

According to some aspects, second Hadamard gate 120 is coupled to a second qubit. Second Hadamard gate 120 is an example of, or includes aspects of, the corresponding element described with reference to FIGS. 2 and 3.

According to some aspects, first NOT gate 125 is coupled to a third qubit, and coupled at a first NOT gate 125 control input to the second Hadamard gate 120 at a second Hadamard gate 120 output. First NOT gate 125 is an example of, or includes aspects of, the corresponding element described with reference to FIGS. 2 and 3.

According to some aspects, second NOT gate 130 is coupled to the second Hadamard gate 120 output, and is coupled at a second NOT gate 130 control input to the first qubit and receives the first value from the first qubit. Second NOT gate 130 is an example of, or includes aspects of, the corresponding element described with reference to FIGS. 2 and 3.

According to some aspects, first qubit measurement 135 is coupled to the first Hadamard gate 115 at a first Hadamard gate 115 output, wherein the first qubit measurement 135 is destructive of the first qubit. First qubit measurement 135 is an example of, or includes aspects of, the corresponding element described with reference to FIGS. 2 and 3.

According to some aspects, second qubit measurement 140 is coupled to the second NOT gate 130 output, wherein the second qubit measurement 140 is destructive of the second qubit. Second qubit measurement 140 is an example of, or includes aspects of, the corresponding element described with reference to FIGS. 2 and 3.

According to some aspects, third NOT gate 145 is coupled to a first NOT gate 125 output of the first NOT gate 125, and coupled at a third NOT gate 145 control input to the second qubit measurement 140. Third NOT gate 145 is an example of, or includes aspects of, the corresponding element described with reference to FIGS. 2 and 3.

According to some aspects, Z gate 150 is coupled to the first qubit measurement 135 at a control input of the Z gate 150, is coupled at a third NOT gate 145 output to the third NOT gate 145, and provides a third qubit output. Z gate 150 is an example of, or includes aspects of, the corresponding element described with reference to FIGS. 2 and 3.

According to some aspects, input switch 155 is coupled to the first qubit, whereby the first Hadamard gate 115 is coupled to the first qubit via the input switch 155. Input switch 155 is an example of, or includes aspects of, the corresponding element described with reference to FIGS. 2, 3, and 6.

According to some aspects, output switch 160 is coupled to a Z gate 150 output of the Z gate 150, and provides a feedback path to the input switch 155, whereby the third qubit output is provided via the output switch 160, wherein the Z gate 150 output can be selectively used to provide a first Hadamard gate 115 input to the first Hadamard gate 115, and the third qubit output. Output switch 160 is an example of, or includes aspects of, the corresponding element described with reference to FIGS. 2, 3, and 6.

According to some aspects, AQM system 110 teleports a first value of a first qubit to a third qubit by the help of a second qubit, where the teleporting is started by forcing the second qubit to zero and forcing the third qubit to zero. In some examples, AQM system 110 performs a first Hadamard gate 115 on the second qubit. In some examples, AQM system 110 performs a second Hadamard gate 120 on the first qubit. In some examples, AQM system 110 performs a NOT gate on the third qubit, controlled by the second qubit.

In some examples, AQM system 110 measures the second qubit, thereby destroying the second qubit, and AQM system 110 uses the second qubit to perform a controlled NOT on the third qubit. In some examples, AQM system 110 measures the first qubit, thereby destroying the first qubit, and AQM system 110 controls a Z gate 150 on the third qubit as a function of the measuring of the first qubit, thereby effectuating teleportation of first value from the first qubit to the third qubit.

In some examples, AQM system 110 forces the first qubit to zero. In some examples, AQM system 110 forces the second qubit to zero. In some examples, AQM system 110 uses the first value of the third qubit in a gate calculation. In some examples, AQM system 110 teleports the first value of the third qubit to the first qubit by the help of the second qubit, where the teleporting is started by forcing the first qubit to zero and forcing the second qubit to zero. In some examples, AQM system 110 performs a third Hadamard gate on the second qubit. In some examples, AQM system 110 performs a fourth Hadamard gate on the third qubit. In some examples, AQM system 110 performs a NOT gate on the first qubit, controlled by the second qubit. In some examples, AQM system 110 measures the second qubit, thereby destroying the second qubit, and AQM system 110 uses the second qubit to perform a controlled NOT on the first qubit. In some examples, AQM system 110 measures the third qubit, thereby destroying the third qubit, and AQM system 110 controls a Z gate 150 on the first qubit as a function of the measuring of the third qubit, thereby effectuating teleportation of the first value from the third qubit to the first qubit. In some examples, AQM system 110 forces the third qubit to zero and forces the second qubit to zero. In some examples, AQM system 110 uses the first value of the first qubit in a gate calculation. In some examples, AQM system 110 pass the first value back and forth between the first qubit and the third qubit by alternately repeating the steps in Claim 1 and the steps in Claim 3. In some aspects, a cycle period for the alternately repeating is less than a decoherence time of the first qubit, the second qubit, and the third qubit.

Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

A processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor is configured to operate a memory array using a memory controller. In other cases, a memory controller is integrated into the processor. In some cases, the processor is configured to execute computer-readable instructions stored in a memory to perform various functions. In some embodiments, a processor includes special purpose components for modem processing, baseband processing, digital signal processing, or transmission processing.

Software may include code to implement aspects of the present disclosure. Software may be stored in a non-transitory computer-readable medium such as system memory or other memory. In some cases, the software may not be directly executable by the processor but may cause a computer (e.g., when compiled and executed) to perform functions described herein.

In many cases, a Hadamard transform may be used in quantum computing (e.g., by computing device 170). The Hadamard transform (also known as the Walsh-Hadamard transform, Hadamard-Rademacher-Walsh transform, Walsh transform, or Walsh-Fourier transform) is an example of a generalized class of Fourier transforms. A Hadamard transform performs an orthogonal, symmetric, involutive, linear operation on 2^{m} real numbers (or complex, or hypercomplex numbers, although the Hadamard matrices themselves are purely real).

The Hadamard transform can be regarded as being built out of size-2 discrete Fourier transforms (DFTs), and is in fact equivalent to a multidimensional discrete Fourier transform (DFT) of 2×2× . . . ×2×2. It decomposes an arbitrary input vector into a superposition of Walsh functions.

The Hadamard transform Hₘ is a 2^{m}×2^{m} matrix, the Hadamard matrix (scaled by a normalization factor), that transforms 2^{m} real numbers xₙ into 2^{m} real numbers Xₖ. The Hadamard transform can be defined in two ways: recursively, or by using the binary (base-2) representation of the indices n and k.

Recursively, we define the 1×1 Hadamard transform H₀ by the identity H₀=1, and then define Hₘ for m>0 by:

$${H}_{m} = \frac{1}{\sqrt{2}} ( \begin{matrix}{H}_{m - 1} & {H}_{m - 1} \\ {H}_{m} 1 & - {H}_{m - 1}\end{matrix} )$$

where

$$\frac{1}{\sqrt{2}}$$

is a normalization that, in some cases, may be omitted.

For m>1, Hₘ may also be defined by:

$${H}_{m} = {H}_{1} ⊗ {H}_{m - 1}$$

where ⊗ represents the Kronecker product. As such, other than this normalization factor, the Hadamard matrices may be made up entirely of 1 and −1.

In the classical domain, the Hadamard transform can be computed in n log n operations (n=2^{m}), using the fast Hadamard transform algorithm. In the quantum domain, the Hadamard transform can be computed in O(1) time, as it is a quantum logic gate that can be parallelized.

The 2×2 Hadamard transforms H₁ is the quantum logic gate known as the Hadamard gate, and the application of a Hadamard gate to each qubit of an n-qubit register in parallel is equivalent to the Hadamard transform Hₙ.

In quantum computing, the Hadamard gate is a one-qubit rotation, mapping the qubit-basis states (e.g., |0 [symbol] and |1 [symbol] ) to two superposition states with equal weight of the computational basis states |0 [symbol] and |1 [symbol] . In some cases, the phases may be chosen so that:

$$H = \frac{\vert 0 〉 + \vert 1 〉}{\sqrt{2}} 〈 0 \vert + \frac{\vert 0 〉 - \vert 1 〉}{\sqrt{2}} 〈 1 \vert$$

in Dirac notation, which corresponds to the transformation matrix

$${H}_{1} = \frac{1}{\sqrt{2}} ( \begin{matrix}1 & 1 \\ 1 & - 1\end{matrix} )$$

in the |0 [symbol] , |1 [symbol] basis, also known as the computational basis. In some cases, the states

$$\frac{\vert 0 〉 + \vert 1 〉}{\sqrt{2}} and \frac{\vert 0 〉 - \vert 1 〉}{\sqrt{2}}$$

may be known as |+ [symbol] and |− [symbol] respectively, and together may constitute a polar basis in quantum computing.

Accordingly, Hadamard gate operations may include:

$$H ( \vert 0 〉 ) = \frac{1}{\sqrt{2}} \vert 0 〉 + \frac{1}{\sqrt{2}} \vert 1 〉 = : \vert + 〉$$

$$H ( \vert 1 〉 ) = \frac{1}{\sqrt{2}} \vert 0 〉 - \frac{1}{\sqrt{2}} \vert 1 〉 = : \vert - 〉$$

$$H ( \vert + 〉 ) = H ( \frac{1}{\sqrt{2}} \vert 0 〉 + \frac{1}{\sqrt{2}} \vert 1 〉 ) = \frac{1}{2} ( \vert 0 〉 + \vert 1 〉 ) + \frac{1}{2} ( \vert 0 〉 - \vert 1 〉 ) = \vert 0 〉$$

$$H ( \vert - 〉 ) = H ( \frac{1}{\sqrt{2}} \vert 0 〉 - \frac{1}{\sqrt{2}} \vert 1 〉 ) = \frac{1}{2} ( \vert 0 〉 + \vert 1 〉 ) - \frac{1}{2} ( \vert 0 〉 - \vert 1 〉 ) = \vert 1 〉$$

One application of the Hadamard gate to either a 0 or 1 qubit may produce a quantum state that, if observed, will be a 0 or 1 with equal probability (e.g., as seen above in the first two Hadamard gate operations, similar to a 1:1 probability in the standard probabilistic model of computation). However, if the Hadamard gate is applied twice in succession (e.g., as is effectively being done in the last two operations), then the final state may always be the same as the initial state.

Computing the quantum Hadamard transform may include the application of a Hadamard gate to each qubit individually because of the tensor product structure of the Hadamard transform. This result means the quantum Hadamard transform includes log n operations, compared to the classical case of n log n operations.

Many quantum computing algorithms may use the Hadamard transform as an initial step (e.g., since the Hadamard operation maps m qubits initialized with |0 [symbol] to a superposition of all 2^{m} orthogonal states in the |0 [symbol] , |1 [symbol] basis with equal weight).

As described herein (e.g., with reference to, for example, FIGS. 2-7), AQM systems, and techniques for mitigating decoherence in quantum computing systems, may implement quantum gates including single qubit Hadamard gates (e.g., ‘H gate’), Controlled-Not gates (CNOT or CX gates) gate, and Controlled-Z gates (‘Z gate’). Moreover, an unknown quantum state, ψ, of a qubit may be denoted (e.g., in Dirac bracket notation) as |ψ [symbol] =α|0 [symbol] +β|1 [symbol] , where α, β∈ [symbol] and α²=β²=1. The basis states may be represented by |0 [symbol] and |1 [symbol] , where

$$\vert 0 〉 = ( \begin{matrix}1 \\ 0\end{matrix} ) and \vert 1 〉 = ( \begin{matrix}1 \\ 0\end{matrix} ) .$$

Further, two switches on the memory input (write) and output (readout) circuits may be implemented, to select between storing or outputting a qubit vs recirculating the stored qubit where, α∈[0,1] and β=\sqrt{1−α²}e^{iϕ} and ϕ is an arbitrary phase.

Separable multiple qubit states can be written as direct products of all qubits (e.g., such as

$$\vert {q}_{1} {q}_{2} … {q}_{n} 〉 = {\prod }_{i = 1}^{n} ⊗ \vert {q}_{i} 〉 ) .$$

However, in some cases, not every state can be written this way. Qubits that are entangled may not be written as separable direct products. For example, a two qubit Bell state may be written as

$$\vert {β}_{0 , 0} 〉 = \frac{1}{\sqrt{2}} ( \vert 00 〉 + \vert 11 〉 ) .$$

That this state may not be written in separable (factorized) form for the first and second qubits. This is a paradigm example of bipartite entanglement between two qubits, which implies a correlation in simultaneous measurements of both qubits.

For multi-qubit states in the measurement basis, the order of the qubits matters. For example, a separable three qubit state for qubits q₁, q₂, q₃, may be written as |100 [symbol] =|1 [symbol] ₁⊗|0 [symbol] ₂⊗|0 [symbol] ₃. That is, interpreting the state descriptor on the LHS as a binary number, each qubit corresponds to a specific power of two in the binary descriptor.

FIG. 2 shows an example of an AQM system according to aspects of the present disclosure. The example shown includes first Hadamard gate 200, second Hadamard gate 205, first NOT gate 210, second NOT gate 215, first qubit measurement 220, second qubit measurement 225, Z gate 230, input switch 235, output switch 240, and third NOT gate 245.

FIG. 2 illustrates aspects of a AQM procedure for an example scenario of single-qubit storage. For instance, a AQM computing device may be described as a quantum teleportation circuit with a feedback loop (e.g., as shown in FIG. 2).

In accordance with the no-cloning theorem, qubits cannot be copied, in the sense that one cannot take a source qubit and target qubit, both with different quantum states, and transform the target qubit to the same state as the source qubit to end up with two independent copies of the source qubit that could give different values when measured. However, an entangled multiqubit analog of the source state can be produced, or the source state can be “teleported” to a second qubit, at the expense of measuring the first qubit, destroying it's state but using that information to reproduce the same state in the target qubit.

In the example circuit of FIG. 2 (e.g., illustrating aspects of the single qubit teleportation protocol), an initial unknown state |ψ [symbol] is teleported from the first qubit to the third qubit in the circuit. The initial state |ψ [symbol] is made to interact in a certain way with an entangled state of the second and third qubits (e.g., which are initialized or set to |0 [symbol] ), and then the first and second qubits are measured (e.g., first qubit measurement 220 and second qubit measurement 225), as denoted in the diagram by the semicircular symbols in FIG. 2. Next, the classical information from those measurements (e.g., from first qubit measurement 220 and second qubit measurement 225) is used to select and transform the final state of the third qubit to the initial state |ψ [symbol] . Thus the state of the first qubit is transferred, or “teleported” to the third qubit, at the expense of the loss of this state in the first qubit.

In some aspects, this protocol includes the use of two ancillary qubits (e.g., the 2nd and 3rd qubit), which are initialized in their respective |0 [symbol] states and subsequently entangled (e.g., via input of a small amount of energy for each ancillary qubit).

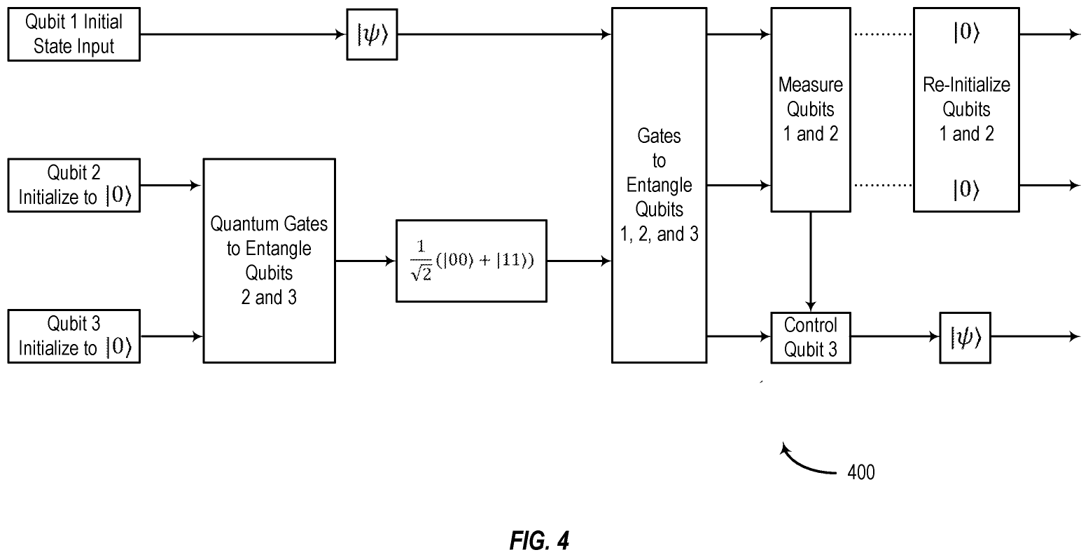

Since a single qubit will generally decohere (e.g., and thus be lost) within a short coherence time (e.g., τ_{c}, where typically τ_{c}<10⁻³ s), the AQM systems and techniques described herein may prolong the memory of state |ψ [symbol] indefinitely by feeding the teleported state in qubit 3 back to qubit 1 and then reinitializing qubits 2 and 3 (e.g., as described in more detail herein, for example, with reference to FIGS. 4-6). For instance, in the example feedback circuit of FIG. 2, the initial state is feedback to qubit 1 and qubits 2 and 3 are reinitialized within a time τ_{f}<τ_{c}. If the amount of energy used to initialize a qubit to |0 [symbol] is ε₀, the |ψ [symbol] may be maintained indefinitely by providing a continuous input power of (e.g., at least) 2ε₀/τ_{f} at a frequency of 1/τ_{f} (e.g., not accounting for the power used to measure qubits 1 and 2 and the power used to transmit the results to qubit 3). A typical optical qubit may have energy on the order a few eV where 1 eV≈1.6×10⁻¹⁹ J. For an optical qubit with τ_{c}˜10⁻³, and assuming a qubit energy of 1 eV, a minimum power per qubit may be estimated as P_{qubit}˜10⁻¹⁶ W.

Thus, even accounting for multiple qubit registers and unaccounted losses within the circuit, this minimum power requirement is negligible compared to losses in the digital-to-analog (DAC) control circuits and refrigeration, the actual power requirements may be manageable. An optical implementation may be even more efficient (e.g., as optical implementations may not require refrigeration).

The example AQM for a single qubit state in FIG. 2 includes the feedback circuit as well as input and output channels (e.g., which may be controlled by input switch 235 and output switch 240, respectively). For instance, diamond symbols in FIG. 2 may represent switches (e.g., input switch 235 and output switch 240) that select between the input/output channels and the state feedback loop. The input switch 235 couples to qubit 1 and the output switch 240 couples to qubit 3. The switch on the input side of the AQM (e.g., input switch 235) is initially opened to allow a qubit state to be fed into the AQM unit for storage, and then immediately closed within a time<τ_{f} to only allow the stored state to be input, and subsequently recirculate the state from qubit 3. Likewise, the switch at the output channel (e.g., output switch 240) is initially closed to feed back the initial state, but is opened on demand when the qubit state is required to be read out.

The input qubit (e.g., qubit 1 coming in from the input switch 235) doesn't go through first Hadamard gate 200 before entangling with the “middle” qubit, which is shared between the incoming qubit and the qubit information is teleported to. First, qubit 2 (e.g., the “middle” qubit) passes through second Hadamard gate 205.

In some examples, the input to qubit 1 does not have to occur simultaneously with the initialization of qubits 2 and 3. For instance, coherence may be maintained longer based on the idea that they occur asynchronously, with qubits 2 and 3 initialized into the |0 [symbol] states a short time after qubit 1 in input. Coherence is maintained because the state of qubit 1 is teleported or swapped to qubit 3 before the decoherence time for qubit 1 (e.g., such that it is still sufficiently coherent). As such, stored and newly initialized qubits may be initialized out of sync with each other while maintaining coherence.

In some aspects, first Hadamard gate 200, second Hadamard gate 205, first NOT gate 210, second NOT gate 215, third NOT gate 245, Z gate 230, first qubit measurement 220, and second qubit measurement 225 are each examples of, or each include aspects of, their corresponding elements described with reference to FIGS. 1 and 3. Moreover, input switch 235 and output switch 240 are each examples of, or each include aspects of, the corresponding element described with reference to FIGS. 1, 3, and 6.

FIG. 3 shows an example of an AQM system according to aspects of the present disclosure. The example shown includes first Hadamard gate 300, second Hadamard gate 305, first NOT gate 310, second NOT gate 315, first qubit measurement 320, second qubit measurement 325, Z gate 330, input switch 335, output switch 340, QEC circuit 345, and third NOT gate 350.

FIG. 3 illustrates aspects of a AQM procedure for an example scenario of single-qubit storage circuit with a quantum error correcting (QEC) circuit 345 in the feedback circuit.

In practice, quantum teleportation can be affected by noisy quantum channels and qubit loss (e.g., teleportation protocols may not be noiseless). Continuous feedback and restarting with fresh qubits before teleporting the state can maintain coherence of the quantum state (e.g., but may not maintain fidelity by itself). Therefore, an error mitigation protocol may be integrated into a recirculating energy circuit, in order to maintain fidelity of the stored state for as long as possible. Sufficient corrective measures may be incorporated into the design of a AQM, for example, by quantum error correction (QEC) or entanglement distillation protocols. Incorporating these protocols into the AQM circuit with additional ancillary qubits may allow the AQM to store qubits with high fidelity for longer time periods. Although there may be a maximum memory storage time, the use of an AQM may allow the storage time to be extended by many orders of magnitude beyond the decoherence time for any quantum state memory stored with high fidelity.

In some aspects, QEC circuit 345 may include any error correction circuit (e.g., any circuit used for controlling errors in data over unreliable or noisy communication channels) sufficient to maintain fidelity within the AQM for a reasonably long time (e.g., such as a five-qubit stabilizer error correction circuit).

As described above, the time that an input qubit is “written” (also via teleportation, unless it's an optical embodiment, in which case it might just be a photon input) into qubit 1 and the time that qubits 2 and 3 are initialized may generally be out of time sync (e.g., by some time less than the decoherence time of a single qubit). And, likewise, there may be a similar lag in the feedback loop, so that the initializations of the “fresh” qubits are out of phase with the copy operations of the stored qubit. In fact, it need not be the case that the teleportation copy (or swap) operation is performed on every pass of the stored qubit through the loop, if the decoherence time is long enough such that the operation may be performed less frequently.

First Hadamard gate 300 is an example of, or includes aspects of, the corresponding element described with reference to FIGS. 1 and 2. Second Hadamard gate 305 is an example of, or includes aspects of, the corresponding element described with reference to FIGS. 1 and 2.

First NOT gate 310 is an example of, or includes aspects of, the corresponding element described with reference to FIGS. 1 and 2. Second NOT gate 315 is an example of, or includes aspects of, the corresponding element described with reference to FIGS. 1 and 2. Third NOT gate 350 is an example of, or includes aspects of, the corresponding element described with reference to FIGS. 1 and 2. Z gate 330 is an example of, or includes aspects of, the corresponding element described with reference to FIGS. 1 and 2.

First qubit measurement 320 is an example of, or includes aspects of, the corresponding element described with reference to FIGS. 1 and 2. Second qubit measurement 325 is an example of, or includes aspects of, the corresponding element described with reference to FIGS. 1 and 2.

Input switch 335 is an example of, or includes aspects of, the corresponding element described with reference to FIGS. 1, 2, and 6. Output switch 340 is an example of, or includes aspects of, the corresponding element described with reference to FIGS. 1, 2, and 6.

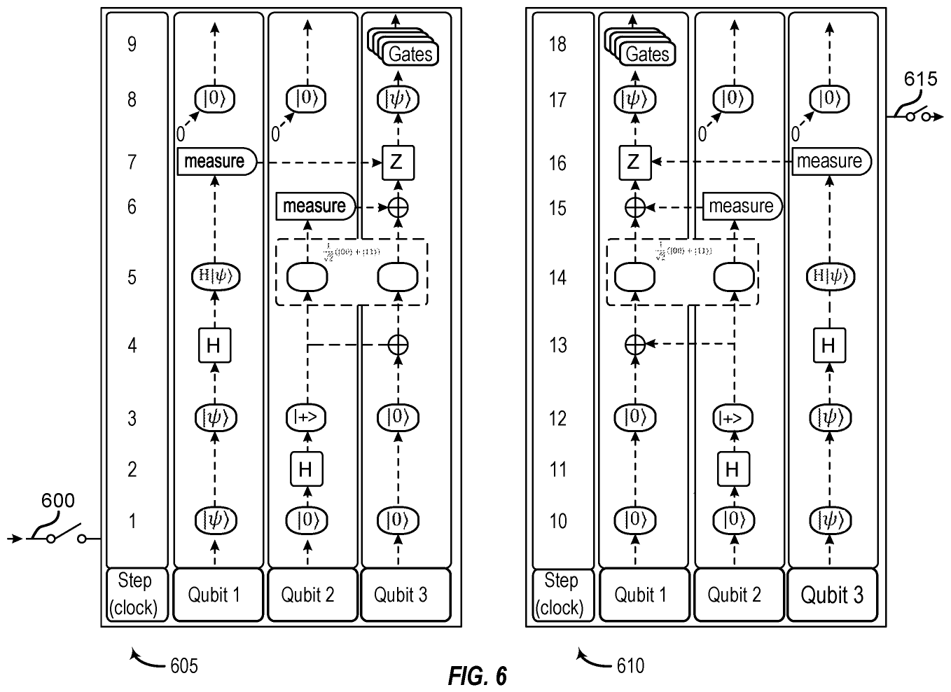

FIG. 4 shows an example of an AQM block diagram according to aspects of the present disclosure. First AQM sequence 400 is an example of, or includes aspects of, the corresponding element described with reference to FIG. 6.

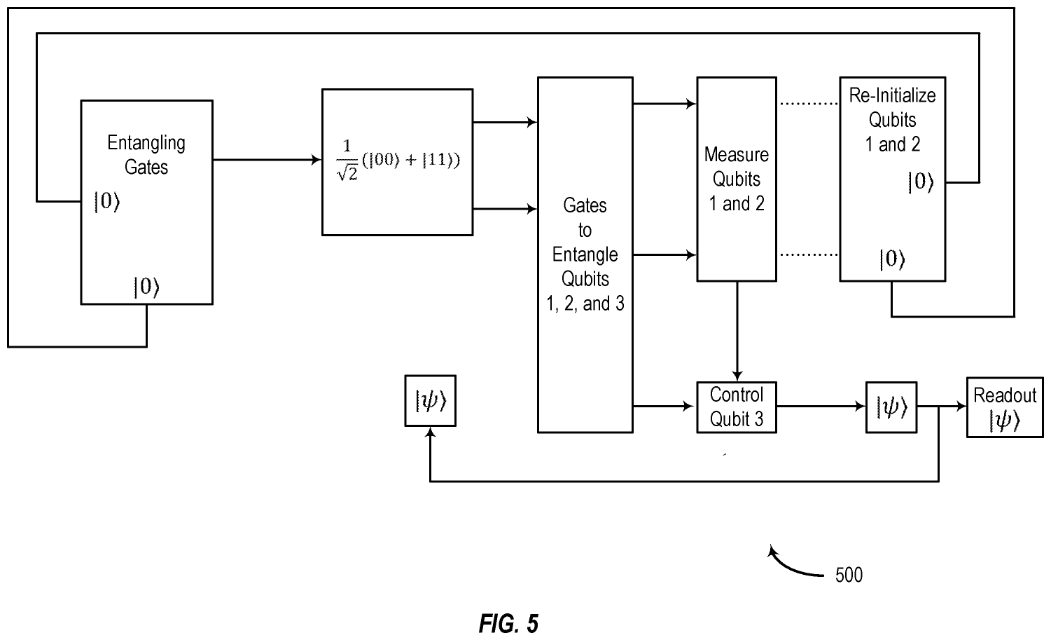

First AQM sequence 400 may illustrate aspects of teleporting or swapping the state from qubit 1 to qubit 3 before the decoherence time for qubit 1 (e.g., such that sufficient coherence is maintained). For example, in some cases, qubits 2 and 3 may be initialized into the |0 [symbol] states a short time after qubit 1 is input. Ultimately, as described in more detail herein, the |ψ [symbol] state is transported from qubit 1 to qubit 3 before the decoherence time for qubit 1. In some aspects, qubits 1, 2, and 3 of FIG. 4 may ultimately be cycled through the circuit (e.g., as described in more detail herein, for example, with reference to FIGS. 5 and 6).

FIG. 5 shows an example of an AQM block diagram according to aspects of the present disclosure. Second AQM sequence 500 is an example of, or includes aspects of, the corresponding element described with reference to FIG. 6.

Second AQM sequence 500 may show aspects of a second cycle of a AQM system described herein. For example, the |ψ [symbol] state of qubit 3 of first AQM sequence 400 may be taken as qubit 1 of second AQM sequence 500 (e.g., where qubits 1 and 2 may be re-initialized to |0 [symbol] states.)

FIG. 6 shows an example of an AQM block diagram according to aspects of the present disclosure. The example shown includes input switch 600, first AQM sequence 605, second AQM sequence 610, and output switch 615.

As described herein, the input to qubit 1 does not have to occur simultaneously with the initialization of qubits 2 and 3 (e.g., as coherence may be maintained longer based on the idea that qubit 1 input and qubit 2/3 initialization occur asynchronously, with qubits 2 and 3 initialized into the |0> states a short time after qubit 1 is input). In step 8 of FIG. 6, for instance, the stored |ψ [symbol] state is already stored in qubit 3 before qubits 1 and 2 are initialized to |0 [symbol] and stored in step 10 of FIG. 6.

Input switch 600 is an example of, or includes aspects of, the corresponding element described with reference to FIGS. 1-3. First AQM sequence 605 is an example of, or includes aspects of, the corresponding element described with reference to FIG. 4. Second AQM sequence 610 is an example of, or includes aspects of, the corresponding element described with reference to FIG. 5. Output switch 615 is an example of, or includes aspects of, the corresponding element described with reference to FIGS. 1-3.

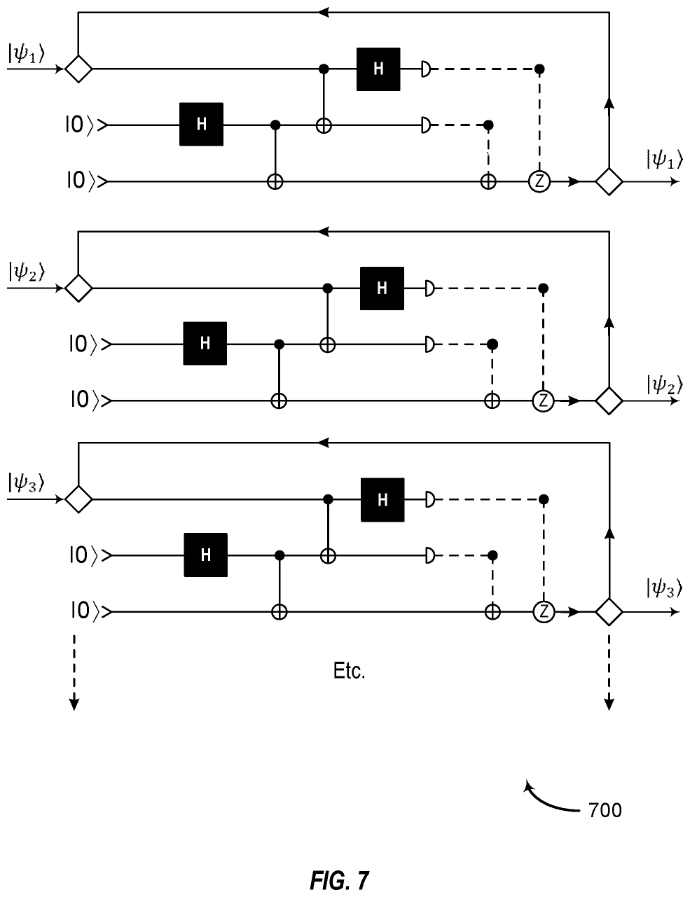

FIG. 7 shows an example of an AQM system according to aspects of the present disclosure. For instance, FIG. 7 may illustrate an extension of single qubit register circuits (e.g., as described herein, for example, with reference to FIGS. 2 and 3) to multi-qubit registers.

For instance, some quantum computing systems may desire or demand the capability of storing a large register of qubits (e.g., rather than a single qubit). Such implementations may implement two additional ancillary qubits for each qubit stored. The teleportation circuits with feedback described herein may then be applied to each qubit to accomplish this (e.g., aspects of which are illustrated in FIG. 7).

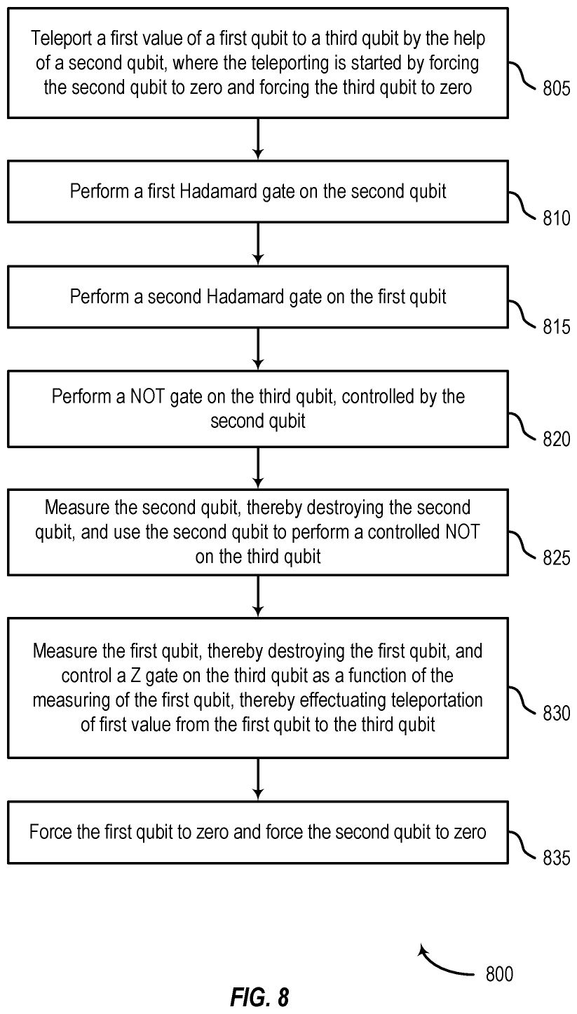

FIG. 8 shows an example of a method 800 for quantum memory according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system teleports a first value of a first qubit to a third qubit by the help of a second qubit, where the teleporting is started by forcing the second qubit to zero and forcing the third qubit to zero. In some cases, the operations of this step refer to, or may be performed by, AQM system as described with reference to FIG. 1.

At operation 810, the system performs a first Hadamard gate on the second qubit. In some cases, the operations of this step refer to, or may be performed by, AQM system as described with reference to FIG. 1. In some cases, the operations of this step refer to, or may be performed by, first Hadamard gate as described with reference to FIGS. 1-3.

At operation 815, the system performs a second Hadamard gate on the first qubit. In some cases, the operations of this step refer to, or may be performed by, AQM system as described with reference to FIG. 1. In some cases, the operations of this step refer to, or may be performed by, second Hadamard gate as described with reference to FIGS. 1-3.

At operation 820, the system performs a NOT gate on the third qubit, controlled by the second qubit. In some cases, the operations of this step refer to, or may be performed by, AQM system as described with reference to FIG. 1. In some cases, the operations of this step refer to, or may be performed by, first NOT gate as described with reference to FIGS. 1-3.

At operation 825, the system measures the second qubit, thereby destroying the second qubit, and uses the second qubit to perform a controlled NOT on the third qubit. In some cases, the operations of this step refer to, or may be performed by, AQM system as described with reference to FIG. 1. In some cases, the operations of this step refer to, or may be performed by, second qubit measurement as described with reference to FIGS. 1-3.

At operation 830, the system measures the first qubit, thereby destroying the first qubit, and controls a Z gate on the third qubit as a function of the measuring of the first qubit, thereby effectuating teleportation of first value from the first qubit to the third qubit. In some cases, the operations of this step refer to, or may be performed by, AQM system as described with reference to FIG. 1. In some cases, the operations of this step refer to, or may be performed by, first qubit measurement as described with reference to FIGS. 1-3.

At operation 835, the system forces the first qubit to zero and forces the second qubit to zero. In some cases, the operations of this step refer to, or may be performed by, AQM system as described with reference to FIG. 1.

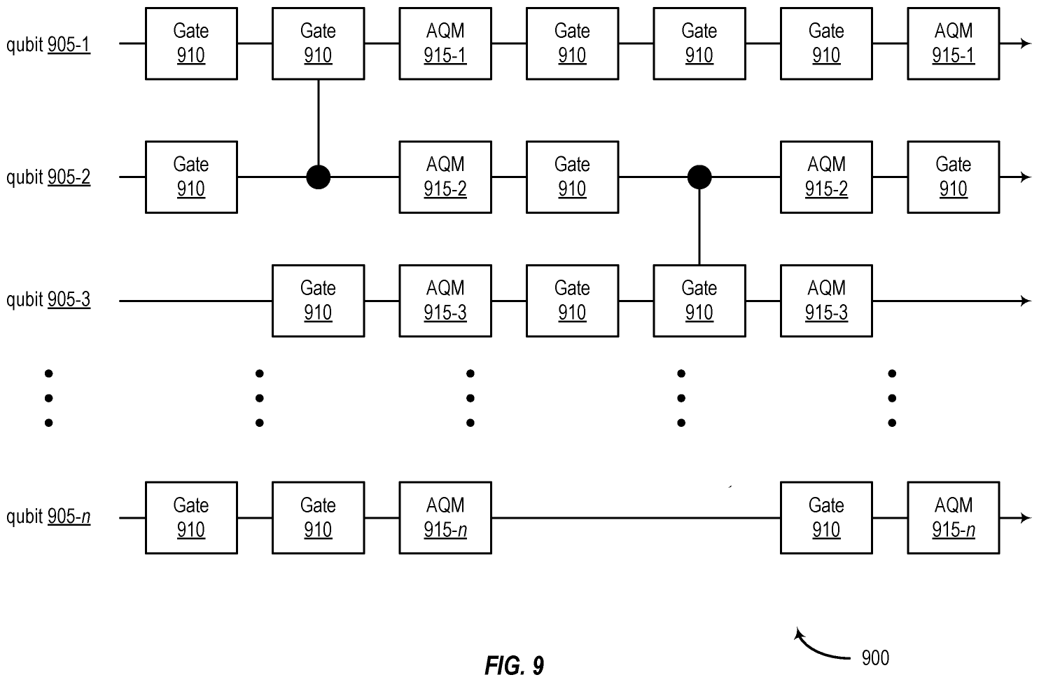

FIG. 9 shows an example of an AQM computing system 900 according to aspects of the present disclosure. In one aspect, AQM computing system 900 includes qubits 905, gates 910, and AQM processes 915 (e.g., performed via one or more aspects of AQM circuits described herein).

For example, FIG. 9 illustrates an example AQM use case. A quantum circuit (e.g., a ‘score’) with n qubits and arbitrary gates are shown in FIG. 9. In this example, time flows from left to right (e.g., on the x-axis). Typically, qubit decoherence may occur after a small number of gates (e.g., as each qubit may only “pass through” a limited number of gates before decohering). However, the insertion of AQM processes (e.g., AQM processes described herein) into the clock sequence for each qubit may actively maintain qubit coherence and generally may keep qubits of the quantum computing system from decoherence. Such may allow for quantum circuits to run for longer time durations, thereby increasing computational volume (e.g., the number of qubits (N_{q}) multiplied by the number of gates (N_{g})) of quantum computers and quantum computing systems).

Accordingly, the present disclosure includes the following aspects.

A method, apparatus, non-transitory computer readable medium, and system for mitigating decoherence in a quantum computing device is described. One or more aspects of the method, apparatus, non-transitory computer readable medium, and system include teleporting a first value of a first qubit to a third qubit by the help of a second qubit, wherein the teleporting is started by forcing the second qubit to zero and forcing the third qubit to zero; performing a first Hadamard gate on the second qubit; performing a second Hadamard gate on the first qubit; performing a NOT gate on the third qubit, controlled by the second qubit; measuring the second qubit, thereby destroying the second qubit, and using the second qubit to perform a controlled NOT on the third qubit; measuring the first qubit, thereby destroying the first qubit, and controlling a Z gate on the third qubit as a function of the measuring of the first qubit, thereby effectuating teleportation of first value from the first qubit to the third qubit; and forcing the first qubit to zero, and forcing the second qubit to zero.

Some examples of the method, apparatus, non-transitory computer readable medium, and system further include using the first value of the third qubit in a gate calculation.

Some examples of the method, apparatus, non-transitory computer readable medium, and system further include teleporting the first value of the third qubit to the first qubit by the help of the second qubit, wherein the teleporting is started by forcing the first qubit to zero and forcing the second qubit to zero. Some examples further include performing a third Hadamard gate on the second qubit. Some examples further include performing a fourth Hadamard gate on the third qubit. Some examples further include performing a NOT gate on the first qubit, controlled by the second qubit. Some examples further include measuring the second qubit, thereby destroying the second qubit, and using the second qubit to perform a controlled NOT on the first qubit. Some examples further include measuring the third qubit, thereby destroying the third qubit, and controlling a Z gate on the first qubit as a function of the measuring of the third qubit, thereby effectuating teleportation of the first value from the third qubit to the first qubit. Some examples further include forcing the third qubit to zero and forcing the second qubit to zero.

Some examples of the method, apparatus, non-transitory computer readable medium, and system further include using the first value of the first qubit in a gate calculation.

Some examples of the method, apparatus, non-transitory computer readable medium, and system further include passing the first value back and forth between the first qubit and the third qubit by alternately repeating the steps in Claim 1 and the steps in Claim 3.

In some aspects, a cycle period for the alternately repeating is less than a decoherence time of the first qubit, the second qubit, and the third qubit.

An active quantum memory system, a method for manufacturing active quantum memory systems, and techniques for using active quantum memory systems are described. One or more aspects of the apparatus, system, and methods include a first Hadamard gate coupled to a first qubit and receiving a value for the first qubit; a second Hadamard gate coupled to a second qubit; a first NOT gate coupled to a third qubit, and coupled at a first NOT gate control input to the second Hadamard gate at a second Hadamard gate output; a second NOT gate coupled to the second Hadamard gate output, and coupled at a second NOT gate control input to the first qubit and receiving the first value from the first qubit; a first qubit measurement coupled to the first Hadamard gate at a first Hadamard gate output, wherein the first qubit measurement is destructive of the first qubit; a second qubit measurement coupled to the second NOT gate output, wherein the second qubit measurement is destructive of the second qubit; a third NOT gate coupled to a first NOT gate output of the first NOT gate, and coupled at a third NOT gate control input to the second qubit measurement; and a Z gate coupled to the first qubit measurement at a control input of the Z gate, and coupled at a third NOT gate output to the third NOT gate, and providing a third qubit output.

Some examples of the apparatus, system, and methods further include an input switch coupled to the first qubit, whereby the first Hadamard gate is coupled to the first qubit via the input switch. Some examples further include an output switch coupled to a Z gate output of the Z gate, and providing a feedback path to the input switch, whereby the third qubit output is provided via the output switch, wherein the Z gate output can be selectively used to provide a first Hadamard gate input to the first Hadamard gate, and the third qubit output.

### AQM “Swap”

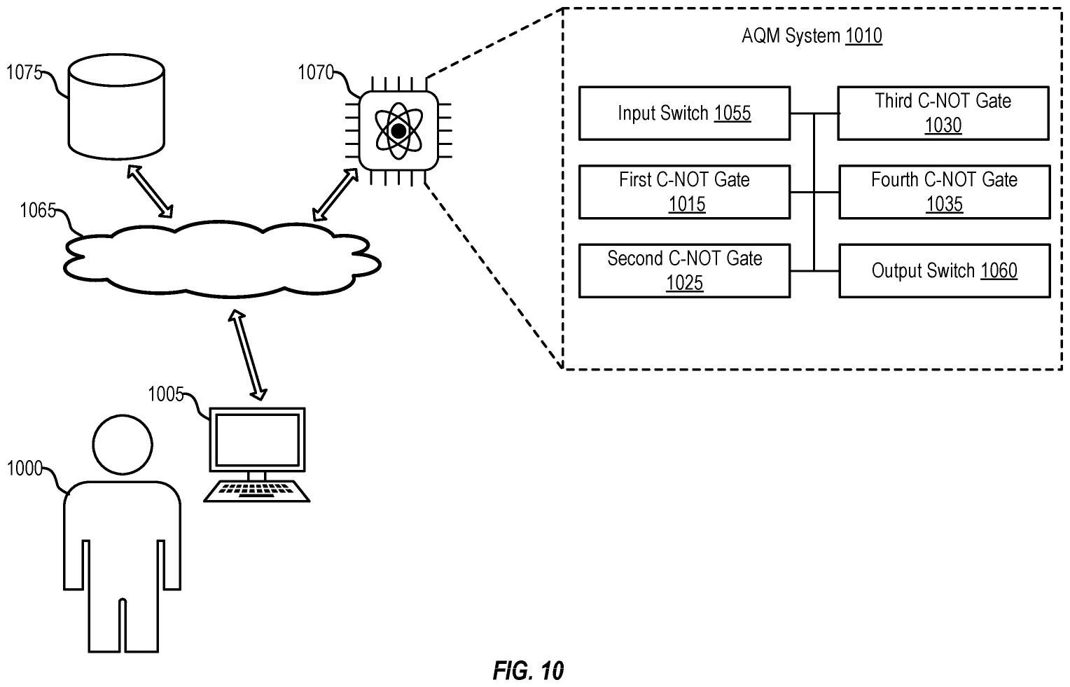

Referring next to FIGS. 10-13, further active quantum memory (AQM) systems and techniques are described for a quantum teleportation circuit with feedback (e.g., which may effectively mitigate decoherence in quantum computing systems). One or more aspects of the systems and techniques described herein may enable the indefinite storage of one or more qubits via a sequence of quantum teleportations involving the rapid periodic executions of a standard teleportation protocol with feedback (e.g., provided the total feedback cycle time is less than the decoherence time for a qubit).

FIG. 10 shows an example of a quantum computing system according to aspects of the present disclosure. The example shown includes user 1000, user device 1005, cloud 1065, computing device 1070, and database 1075.

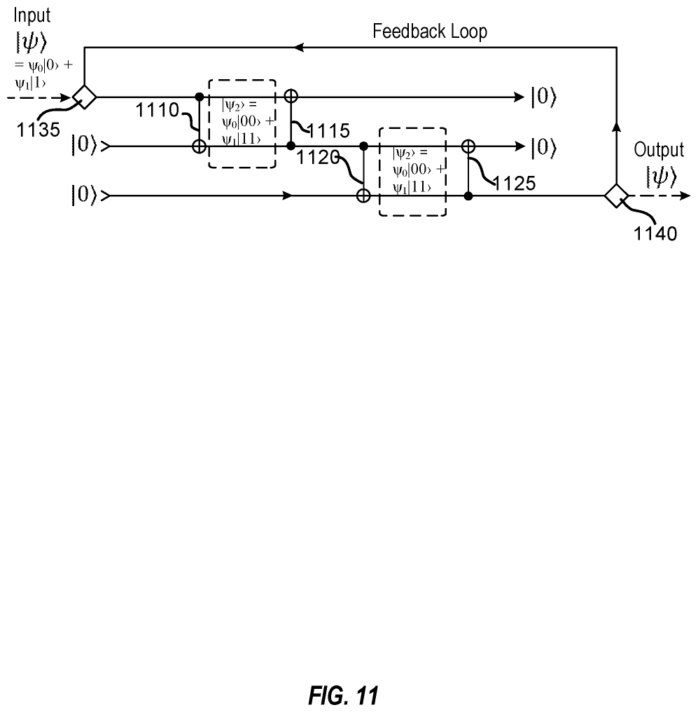

AQM system 1010 provides an active approach to QM (e.g., using a quantum circuit with feedback as described in more detail herein, for example, with reference to FIGS. 11-13). In the example of FIG. 10, AQM system 1010 effectively mitigates decoherence in quantum computing systems implemented at least in part via computing device 1070. For example, user 1000 may utilize a user device 1005, which may access a computing device 1070 (e.g., via cloud 1065) for performing specialized computing tasks such as circuit-based (gate-based) quantum computing tasks, quantum cryptography and security applications, quantum computing algorithm calculations, etc.

A user device 1005 may include any device utilizable or accessible to user 1000, including, but not limited to, a personal computer, laptop computer, mainframe computer, palmtop computer, personal assistant, mobile device, or any other suitable processing apparatus.

A cloud 1065 is a computer network configured to provide on-demand availability of computer system resources, such as data storage and computing power (e.g., such as computing power of computing device 1070). In some examples, the cloud 1065 provides resources without active management by the user 1000.

Computing device 1070 (e.g., a quantum computer, a quantum computing server, etc.) may generally utilize, or represent, one or more collective properties of quantum states for computation tasks. For instance, computing device 170 may utilize quantum state properties such as superposition, interference, entanglement, etc. to perform calculations and solve computational problems. Computing device 170 may be capable of producing outputs and solving certain computational problems more efficiently than classical computers (e.g., such as user device 1005). For example, computing device 1070 may implement quantum computing algorithms that may speed up machine learning tasks, problems such as integer factorization, etc.

In some examples, computing device 1070 may include an adiabatic quantum computer, a quantum annealer computer, a quantum circuit model, a quantum Turing machine, a one-way quantum computer, various quantum cellular automata, etc. In some aspects, computing device 1070 may implement one or more quantum circuits that are based on the quantum bit, or “qubit” (e.g., which in some aspects is somewhat analogous to a bit in classical computation). A qubit can be in a 1 or 0 quantum state, or in a superposition of the 1 and 0 states. When a qubit is measured, however, the qubit is always a 0 or 1 quantum state (e.g., where the probability of either outcome depends on the qubit's quantum state immediately prior to measurement).

In some aspects, computing device 1070 provides one or more functions to users 1000 linked by way of one or more of the various networks. In some cases, the computing device 1070 includes a single microprocessor board, which includes a microprocessor responsible for controlling all aspects of the computing device 1700. In some cases, a computing device 1070 uses microprocessor and protocols to exchange data with other devices 1005 and/or users 1000 on one or more of the networks via hypertext transfer protocol (HTTP), and simple mail transfer protocol (SMTP), although other protocols such as file transfer protocol (FTP), and simple network management protocol (SNMP) may also be used. In some cases, a computing device 1070 is configured to send and receive hypertext markup language (HTML) formatted files (e.g., for displaying web pages). In various embodiments, a computing device 1070 comprises a server, a general purpose computing device, a mainframe computer, a quantum algorithm purpose computing device, a supercomputer, or any other suitable processing apparatus.

A database 1075 is an organized collection of data. For example, a database 1075 stores data in a specified format known as a schema. A database 1075 may be structured as a single database, a distributed database, multiple distributed databases, or an emergency backup database. In some cases, a database controller may manage data storage and processing in a database 1075. In some cases, a user 100 interacts with database controller. In other cases, database controller may operate automatically without user 100 interaction.

Generally, AQM system 1010 may be included in, or implemented by, user device 1005, computing device 1070, or both. In the example of FIG. 10, computing device 1070 includes AQM system 1010. For instance, in the example of FIG. 10, computing device 1070 may include AQM system 1010, and the computing device 1070 may be a server accessed by user device 1005, via cloud 1065, for performing specialized computer tasks (e.g., such as quantum computing operations, quantum computing algorithm computations, etc.).

In one aspect, AQM “swap” system 1010 includes first Controlled-NOT (C-NOT)gate 1015, second Controlled-NOT gate 1025, third Controlled-NOT gate 1030, fourth Controlled-NOT gate 1035, input switch 1055, and output switch 1060.

FIG. 11 shows an example of an AQM “swap” system according to aspects of the present disclosure. The example shown includes first controlled-NOT gate 1110, second controlled-NOT gate 1115, third controlled-NOT gate 1120, fourth controlled-NOT gate 1125, and output switch 1140.

FIG. 11 illustrates aspects of a AQM “swap” procedure for an example scenario of single-qubit storage. For instance, a AQM computing device may be described as a quantum swap circuit with a feedback loop (e.g., as shown in FIG. 11).

In the example circuit of FIG. 11 (e.g., illustrating aspects of the single qubit swap circuit), an initial unknown state |ψ [symbol] is swapped from the first qubit to the third qubit in the circuit. The second and third qubits are initialized or set to |0 [symbol] . The initial state |ψ [symbol] of the first qubit is made to interact in a certain way with an entangled state of the second qubit using consecutive controlled-NOT gates. The state of the entangled first and second qubits is shown after the first controlled-NOT gate 1110: |ψ₂>=ψ₀|00>+ψ₁|11>. After the second controlled-NOT gate 1115, the second and third qubits are entangled by consecutive controlled-NOT gates. The state of the entangled second and third quibits after the third controlled-NOT gate 1120 is shown: |ψ₂>=ψ₀|00>+ψ₁|11>. After the fourth and last controlled-NOT gate 1125, the third qubit has the state |f), which is then output via the output switch 1140 or looped back to the input switch 1135. Thus the state of the first qubit is transferred, or “swapped” to the third qubit, at the expense of the loss of this state in the first qubit.

In some aspects, this protocol includes the use of two ancillary qubits (e.g., the 2nd and 3rd qubit), which are initialized in their respective |0) states and subsequently entangled (e.g., via input of a small amount of energy for each ancillary qubit).

Since a single qubit will generally decohere (e.g., and thus be lost) within a short coherence time (e.g., τ_{c}, where typically τ_{c}<10⁻³ s), the AQM systems and techniques described herein may prolong the memory of state |ψ [symbol] indefinitely by feeding the swapped state in qubit 3 back to qubit 1 and then reinitializing qubits 2 and 3. For instance, in the example feedback circuit of FIG. 11, the initial state is feedback to qubit 1 and qubits 2 and 3 are reinitialized within a time τ_{f}<τ_{c}. If the amount of energy used to initialize a qubit to |0 [symbol] is ε₀, the |ψ [symbol] may be maintained indefinitely by providing a continuous input power of (e.g., at least) 2ε₀/τ_{f} at a frequency of 1/τ_{f} (e.g., not accounting for the power used to measure qubits 1 and 2 and the power used to transmit the results to qubit 3). A typical optical qubit may have energy on the order a few eV where 1 eV≈1.6×10⁻¹⁹ J. For an optical qubit with τ_{c}˜10⁻³, and assuming a qubit energy of 1 eV, a minimum power per qubit may be estimated as P_{qubit}˜10⁻¹⁶ W.

Thus, even accounting for multiple qubit registers and unaccounted losses within the circuit, this minimum power requirement is negligible compared to losses in the digital-to-analog (DAC) control circuits and refrigeration, the actual power requirements may be manageable. An optical implementation may be even more efficient (e.g., as optical implementations may not require refrigeration).

The example AQM for a single qubit state in FIG. 11 includes the feedback circuit as well as input and output channels (e.g., which may be controlled by input switch 1135 and output switch 1140, respectively). For instance, diamond symbols in FIG. 11 may represent switches (e.g., input switch 1135 and output switch 1140) that select between the input/output channels and the state feedback loop. The input switch 1135 couples to qubit 1 and the output switch 1140 couples to qubit 3. The switch on the input side of the AQM (e.g., input switch 1135) is initially opened to allow a qubit state to be fed into the AQM unit for storage, and then immediately closed within a time<τ_{f} to only allow the stored state to be input, and subsequently recirculate the state from qubit 3. Likewise, the switch at the output channel (e.g., output switch 1140) is initially closed to feed back the initial state, but is opened on demand when the qubit state is required to be read out.

In some examples, the input to qubit 1 does not have to occur simultaneously with the initialization of qubits 2 and 3. For instance, coherence may be maintained longer based on the idea that they occur asynchronously, with qubits 2 and 3 initialized into the |0 [symbol] states a short time after qubit 1 in input. Coherence is maintained because the state of qubit 1 is swapped to qubit 3 before the decoherence time for qubit 1 (e.g., such that it is still sufficiently coherent). As such, stored and newly initialized qubits may be initialized out of sync with each other while maintaining coherence.

In some aspects, first controlled-NOT gate 1110, second controlled-NOT gate 1115, third controlled-NOT gate 1120, and fourth controlled-NOT gate 1125, are each examples of, or each include aspects of, their corresponding elements described with reference to FIGS. 10, 12, and 13. Moreover, input switch 1135 and output switch 1140 are each examples of, or each include aspects of, the corresponding element described with reference to FIGS. 2, 3, 6, and 13.

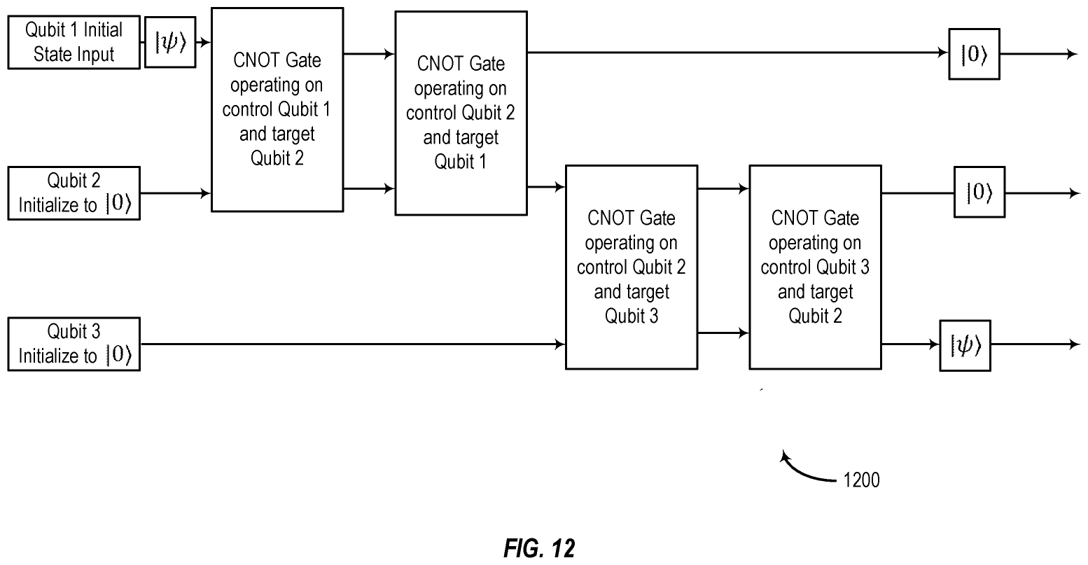

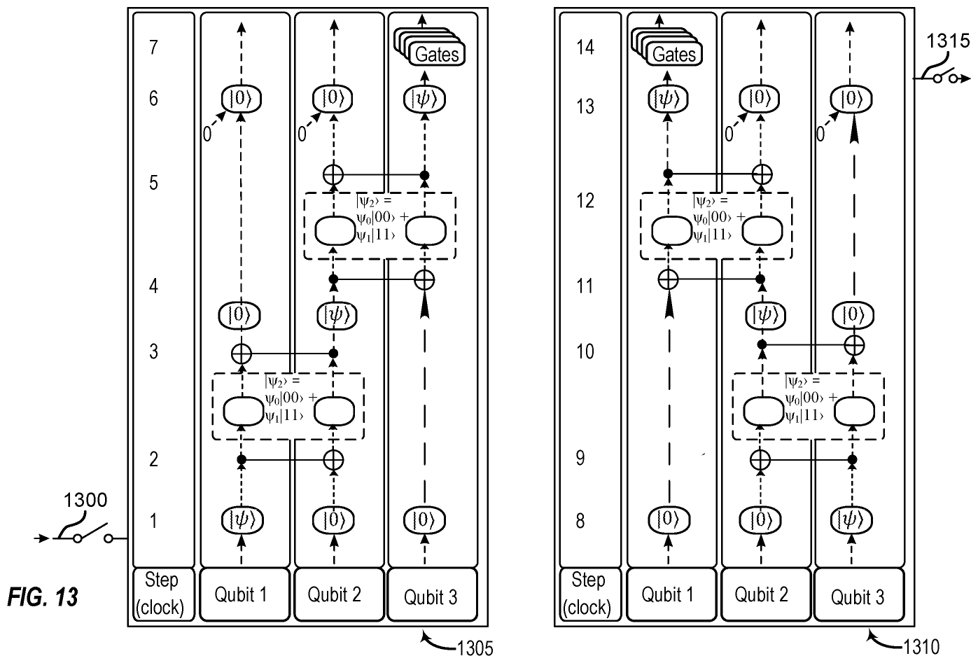

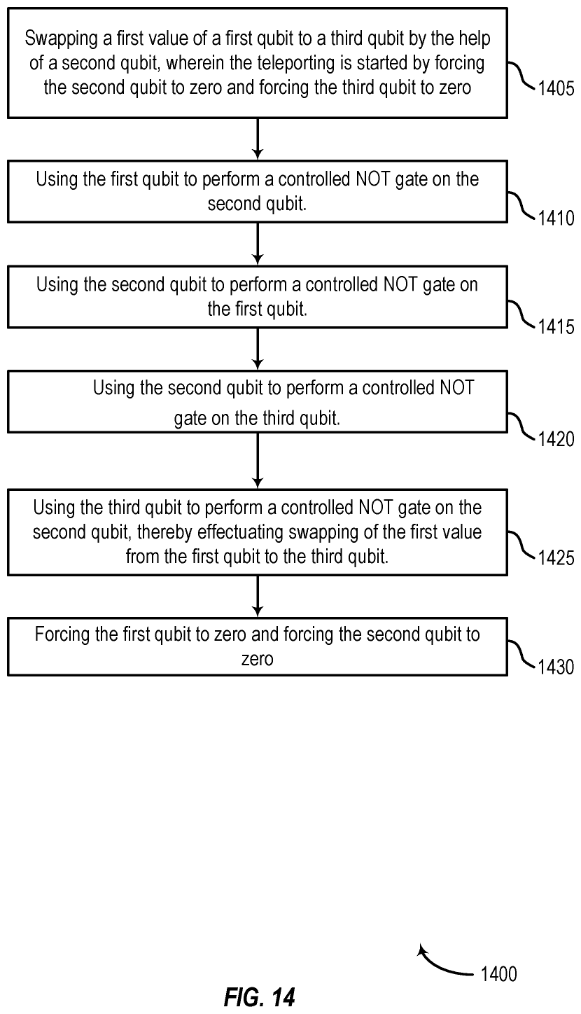

FIG. 12 shows an example of an AQM “swap” block diagram according to aspects of the present disclosure. AQM “swap” sequence 1200 is an example of, or includes aspects of, the corresponding element described with reference to FIG. 13.

AQM “swap” sequence 1200 may illustrate aspects of swapping the state of qubit 1 to qubit 3 before the decoherence time for qubit 1 (e.g., such that sufficient coherence is maintained). For example, in some cases, qubits 2 and 3 may be initialized into the |0 [symbol] states a short time after qubit 1 is input. Ultimately, as described in more detail herein, the |ψ [symbol] state is transported from qubit 1 to qubit 3 before the decoherence time for qubit 1. In some aspects, qubits 1, 2, and 3 of FIG. 11 may ultimately be cycled through the circuit (e.g., as described herein.

FIG. 13 shows an example of an AQM “swap” block diagram according to aspects of the present disclosure. The example shown includes input switch 1300, first AQM “swap” sequence 1305, second AQM “swap” sequence 1310, and output switch 1315.

As described herein, the input to qubit 1 does not have to occur simultaneously with the initialization of qubits 2 and 3 (e.g., as coherence may be maintained longer based on the idea that qubit 1 input and qubit 2/3 initialization occur asynchronously, with qubits 2 and 3 initialized into the |0> states a short time after qubit 1 is input). In step 6 of FIG. 13, for instance, the stored |ψ [symbol] state is already stored in qubit 3 before qubits 1 and 2 are initialized to |0 [symbol] and stored in step 8 of FIG. 13.

Input switch 1300 is an example of, or includes aspects of, the corresponding element described with reference to FIGS. 10-12. First AQM “swap” sequence 1305 is an example of, or includes aspects of, the corresponding element described with reference to FIGS. 10-12. Second AQM “swap” sequence 1310 is an example of, or includes aspects of, the corresponding element described with reference to FIGS. 10-12. Output switch 1315 is an example of, or includes aspects of, the corresponding element described with reference to FIGS. 10-12.

FIG. 14 shows an example of a method 1400 for quantum memory according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1405, the system swaps a first value of a first qubit to a third qubit by the help of a second qubit, where the swapping is started by forcing the second qubit to zero and forcing the third qubit to zero. In some cases, the operations of this step refer to, or may be performed by, AQM system as described with reference to FIG. 10.

At operation 1410, the system uses the first qubit to perform a controlled-NOT gate on the second qubit. In some cases, the operations of this step refer to, or may be performed by, AQM system as described with reference to FIG. 10. In some cases, the operations of this step refer to, or may be performed by, first controlled-NOT gate as described with reference to FIGS. 11-13.

At operation 1415, the system uses the second qubit to perform a controlled-NOT gate on the first qubit. In some cases, the operations of this step refer to, or may be performed by, AQM system as described with reference to FIG. 10. In some cases, the operations of this step refer to, or may be performed by, second controlled-NOT gate as described with reference to FIGS. 11-13.

At operation 1420, the system uses the second qubit to perform a controlled-NOT gate on the third qubit. In some cases, the operations of this step refer to, or may be performed by, AQM system as described with reference to FIG. 10. In some cases, the operations of this step refer to, or may be performed by, first NOT gate as described with reference to FIGS. 11-13.

At operation 1425, the system uses the third qubit to perform a controlled-NOT gate on the second qubit, thereby swapping the first value from the first qubit to the third qubit. In some cases, the operations of this step refer to, or may be performed by, AQM system as described with reference to FIG. 10. In some cases, the operations of this step refer to, or may be performed by, second qubit measurement as described with reference to FIGS. 11-13.

At operation 1430, the system forces the first qubit to zero and forces the second qubit to zero. In some cases, the operations of this step refer to, or may be performed by, AQM system as described with reference to FIG. 10.

Some of the functional units described in this specification have been labeled as modules, or components, to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. A method of mitigating decoherence in a quantum computing device comprising:
swapping a first value of a first qubit to a third value of a third qubit by the help of a second qubit, wherein the swapping is started by forcing the second qubit to zero and forcing the third qubit to zero;
using the first qubit to perform a controlled NOT gate on the second qubit;
using the second qubit to perform a controlled NOT gate on the first qubit;
using the second qubit to perform a controlled NOT gate on the third qubit;
using the third qubit to perform a controlled NOT gate on the second qubit, whereby the first qubit has the third value and the third qubit has the first value; and
forcing the first qubit to zero, and forcing the second qubit to zero.

2. The method of claim 1 further comprising:
using said first value of said third qubit in a gate calculation.

3. The method of claim 1, wherein the first value of the first qubit is a quantum state.

4. The method of claim 1 further comprising:
swapping said first value of said third qubit to said first qubit by the help of said second qubit, wherein the swapping is started by forcing the first qubit to zero and forcing the second qubit to zero;
using the third qubit to perform a controlled NOT gate on the second qubit;
using the second qubit to perform a controlled NOT gate on the third qubit;
using the second qubit to perform a controlled NOT gate on the first qubit;
using the first qubit to perform a controlled NOT gate on the second qubit, thereby swapping the first value of the third qubit to the first qubit; and
forcing the third qubit to zero, and forcing the second qubit to zero.

5. The method of claim 4 further comprising:
using said first value of said first qubit in a gate calculation.

6. The method of claim 4 further comprising:
passing said first value back and forth between the first qubit and the third qubit by alternately repeating the steps in claim 1 and the steps in claim 4.

7. The method of claim 6 wherein a cycle period for said alternately repeating is less than a decoherence time of said first qubit, said second qubit, and said third qubit.

8. The method of claim 4, further comprising, prior to using the first qubit to perform a controlled NOT gate on the second qubit, receiving of the first value of the first qubit via an input switch coupled to the first qubit.

9. The method of claim 8, wherein after opening the input switch is closed within a time period t_{f} that is less than a feedback loop time period for the first value of the first qubit to be swapped to the third qubit and then swapped back to the first qubit.

10. The method of claim 9, wherein the receiving the first value of the first qubit occurs prior to forcing the second qubit to zero and forcing the third qubit to zero.

11. An active quantum memory system comprising:
a first controlled NOT gate coupled to a second qubit and coupled to a first controlled NOT gate control input to a first qubit and receiving a first value for the first qubit;
a second controlled NOT gate coupled to the first qubit and coupled to a second controlled NOT gate control input to an output of the first controlled NOT gate;
a third controlled NOT gate coupled to a third qubit and coupled to a third controlled NOT gate control input to the second qubit;
a fourth controlled NOT gate coupled to the second qubit and coupled to a fourth controlled NOT gate control input to an output of the third controlled NOT gate, thereby effectuating swapping of the first value of the first qubit to the third qubit; and
forcing the first qubit to zero, and forcing the second qubit to zero.

12. The active quantum memory system of claim 11, wherein the first value of the first qubit is a quantum state.

13. The active quantum memory system of claim 11 further comprising:
an input switch coupled to the first qubit, whereby the first controlled NOT gate is coupled to the first qubit via the input switch;
an output switch coupled to the third qubit providing a feedback path to the input switch, wherein the third qubit output is provided via the output switch, whereby the third qubit output can be selectively used to provide a first input to the first controlled NOT gate.
